(19) United States
(12) Patent Application Publication
(10) Pub. No.: US 2004/0143349 A1
(43) Pub. Date: Jul. 22, 2004

(54) Personal audio recording system

(75) Inventors: Dale T. Roberts, San Anselmo, CA (US); Michael W. Mantle, San Rafael, CA (US); Maxwell Wells, Seattle, WA (US); Randall Cook, Kensington, CA (US); Brian Hamilton, Fremont, CA (US)

Correspondence Address: STAAS & HALSEY LLP, SUITE 700, 1201 NEW YORK AVENUE, N.W., WASHINGTON, DC, 20005, US

(73) Assignee: Gracenote, Inc., Emeryville, CA

(21) Appl. No.: 10/694,439

(22) Filed: Oct. 28, 2003

Related U.S. Application Data
(60) Provisional application No. 60/421,576, filed on Oct. 28, 2002.

(51) Int. Cl. G06F 17/00; G10L 11/00

(52) U.S. Cl. 700/94; 704/278

(57) ABSTRACT

Broadcast music, or other audio that a user wants to hear, is recorded based on criteria obtained from a user. Any of a plurality of techniques may be used to identify the audio, alone or in combination with other identification techniques, including length of song, fingerprint recognition of digital or analog audio, scheduled programming, or metadata transmitted in the same or an adjacent channel or frequency. The criteria used to determine whether to save a recording may be based on attributes included in the identification database, such as artist, genre, popularity, station programming, year, signal quality, etc. The audio selected by a user for listening may be recorded, or a programmable tuner or other input selector may automatically record desired music regardless of whether the music is being output for listening. The audio recorded may be obtained from any source, including analog and digital radio, Internet radio streams and removable pre-recorded media.

### CROSS-REFERENCE TO RELATED APPLICATION(S)

This application is related to and claims priority to U.S. provisional application entitled PERSONAL AUDIO RECORDING SYSTEM having serial No. 60/521,476, by Dale T. ROBERTS et al., filed Oct. 28, 2002 and incorporated by reference herein.

### BACKGROUND OF THE INVENTION

1. Field of the Invention

The present invention is directed to a system that simplifies the process of recording and subsequently accessing the recordings of audio, with or without video, obtained from any available source, including analog or digital radio broadcasts, digital streams transmitted over the Internet and removable media.

2. Description of the Related Art

The number of ways that a person can listen to audio that was produced somewhere else continues to increase. A few decades ago, the mass market consumer could rely on a single device capable to tuning in radio stations or playing phonograph records. It was easy to select a phonograph record by printing on the label of the record, or the sleeve, jacket, or cover in which it was stored. The number of radio stations in most locations were small enough that little time was required to find a radio station broadcasting something of interest. The addition of audio and video available via television was similarly limited enough that little time was required to select a program.

Currently, the situation is much different. Audio programs are broadcast via analog and digital radio, satellites and cable television. Digital audio streams are available via computer networks, such as the Internet, in both the equivalent of a radio station programmed by the broadcast source and user selected audio. Any of this audio may be recorded by users in analog or digital form on hard disks permanently mounted in a computer or other device, or on removable media, including tapes and discs of several different sizes and formats, as well as semiconductor or “flash” memory. In addition, pre-recorded audio is distributed by publishers in many of these formats, or formats that can be played by the same type of devices, such as compact discs (CDs), super audio compact discs (SACDs) and digital versatile discs (DVDs).

Managing this wide array of audio sources and recordings to identify and locate audio that a user wants to hear is much more complicated than it was a few decades ago. Several attempts have been made to aid users. Program guides to most sources of broadcast audio programs are available on the Internet, or are sent along with the broadcast audio in a side band or other associated transmission channel. However, the services available for automatically identifying recordings made by a user or copied from another consumer are much more limited. The CDDB® service from Gracenote, Inc. is able to identify almost all compact discs, but is primarily used by computers. There have been many suggestions of ways to identify music and other audio not recorded on a compact disc, including MULTIPLE STEP IDENTIFICATION OF RECORDINGS, U.S. patent application Ser. No. 10/208,189 filed Jul. 31, 2002 and published Feb. 6, 2003 as Published U.S. Patent Application No. 20030028796, and AUTOMATIC IDENTIFICATION OF SOUND RECORDINGS, U.S. patent application Ser. No. 10/200,034 filed Jul. 22, 2002 and published May 8, 2003 as Published U.S. Patent Application No. 20030086341, both incorporated herein by reference, and in articles, such as a Review of Algorithms for Audio Fingerprinting by Cano, et al., in International Workshop on Multimedia Signal Processing, December 2002. However, there has been no successful attempt to use any of these techniques in a device that simplifies access by a user to recordings and helps the user locate audio programs for listening or recording.

### SUMMARY OF THE INVENTION

It is an aspect of the present invention to automatically save music or other audio signals based on predefined criteria when a user is listening to the music.

It is another aspect of the present invention to save audio signals regardless of whether the user is listening by detecting broadcast audio signals that match the predefined criteria.

It is a further aspect of the present invention to detect the broadcast audio signals that match the predefined criteria while the user is listening to other audio signals.

It is yet another aspect of the present invention to determine whether the audio signals match the predefined criteria by identifying the audio signals and using available data, such as determining the length of the audio signals, as a hint to discriminate between recordings that may otherwise be identified as the same.

The above aspects can be attained by a system that records audio by storing user preference criteria; identifying audio signals using a database of previously identified audio signals; determining duration of the audio signals based on the identification; and saving a recording of the audio signals based on the user preference criteria and the duration. Preferably, the audio signals are identified by extracting from the audio signals at least one candidate fingerprint using at least one technique; comparing the at least one candidate fingerprint with at least one database of reference fingerprints for identified recordings; and supplying identification data corresponding to at least one reference fingerprint that said comparing finds matches the at least one candidate fingerprint. To improve the ability to identify the audio signals, a plurality of techniques may be used to extract a plurality of candidate fingerprints. The fingerprinting techniques may include both digital fingerprints and analog fingerprints.

A method according to the present invention may also replace a previous recording if the audio signals match one of the identified recordings which also matches the previous recording and the audio signals are perceivable as having better quality than the previous recording.

In the preferred embodiment, audio files are saved by a client device that communicates with at least one server device storing at least one database of fingerprints from previously recognized audio signals. A plurality of candidate fingerprints and playing time information are sent from the client device to the at least one server device which compares at least one candidate fingerprint with the at least one database and the identification data are sent back from the at least one server device to the client device via a network.

Preferably, at least one of artist, genre and rating is included in the identification data and compared with the user preference criteria to determine whether to save the recording of the audio signals. This identification data is preferably saved with the recording at the client device. This enables a playlist including at least one of the recordings to be automatically generated based on a parameter supplied by a user. The user preference criteria may be modified based on at least part of the identification information saved with the recordings.

In the preferred embodiment, a local device receives the audio signals from a remote device and temporarily stores the audio signals as the recording until the audio signals are identified and then the determination is made whether to save the recording. In this embodiment, the audio signals may be received as either analog signals or digital signals, or both, via a radio broadcast or a digital stream over a computer network, such as the Internet. While the audio signals are being received and temporarily stored, the user may simultaneously be listening to different audio signals from another source. In one embodiment of the invention, the local device includes at least two tuners, so that both sets of audio signals can be received on first and second radio frequencies.

Preferably, a system according to the present invention may be programmed, either locally or via instructions received from another device, such as a computer hosting a web site that provides programming capability, to detect and save audio signals regardless of whether the user is listening to those audio signals or other audio signals. The programming may be based on at least one of broadcast time, a radio station broadcasting the audio signals, radio station format, genre of broadcast audio, popularity of broadcast audio, location of broadcaster, year of broadcast, language of broadcast and minimum quality of the audio signals.

A device according to the present invention may also detect listening habits by identifying the audio signals listened to by the user. The user preference criteria may be modified based on the listening habits of the user, either automatically or in response to commands received from the user. Also, the user may be notified of currently broadcast audio signals matching at least one of the user preference criteria and the listening habits of the user, by scanning broadcast radio signals or program information.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a personal audio recording system according to the present invention, in communication with other devices.

FIG. 2 is a schematic drawing of audio signals during recognition.

FIGS. 3-4 are flowcharts of methods according to the preferred embodiment.

### DETAILED DESCRIPTION OF THE PREFERRED EMBODIMENTS

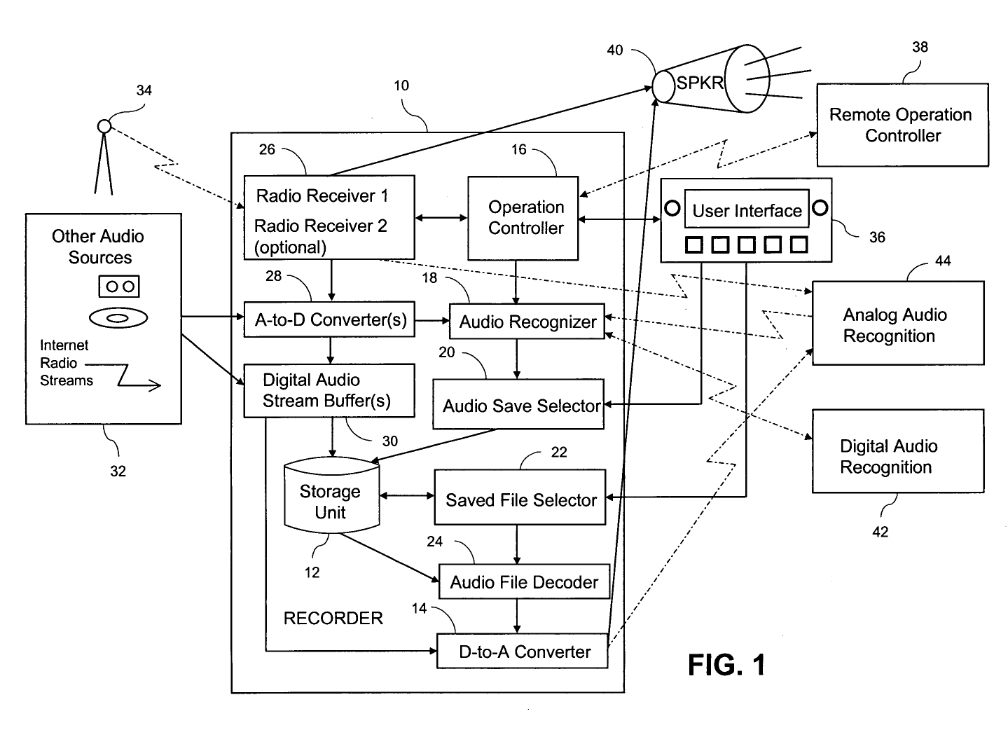

A personal audio recorder 10 according to the present invention is illustrated in FIG. 1, along with other devices to which it may be connected, or communicate with wirelessly. Recorder 10 includes one or more hard drive or other storage device 12 on which recordings are saved for subsequent playback. In the preferred embodiment, the recordings are stored digitally and preferably at least one digital-to-analog converter 14 is included for output to other devices. However, the present invention may be used in conjunction with other devices capable of receiving digital audio signals and therefore, digital-to-audio converter 14 is not essential.

Operation of recorder 10 is controlled by operation controller 16 which may be a microprocessor, such as an ARM9E from Arm, Ltd. of Cambridge, England. Operation controller 16 may be a discrete device performing only the functions of controlling operation and responding to control signals received from a user, or may also be perform the functions of audio recognizer 18 and audio file decoding 24.

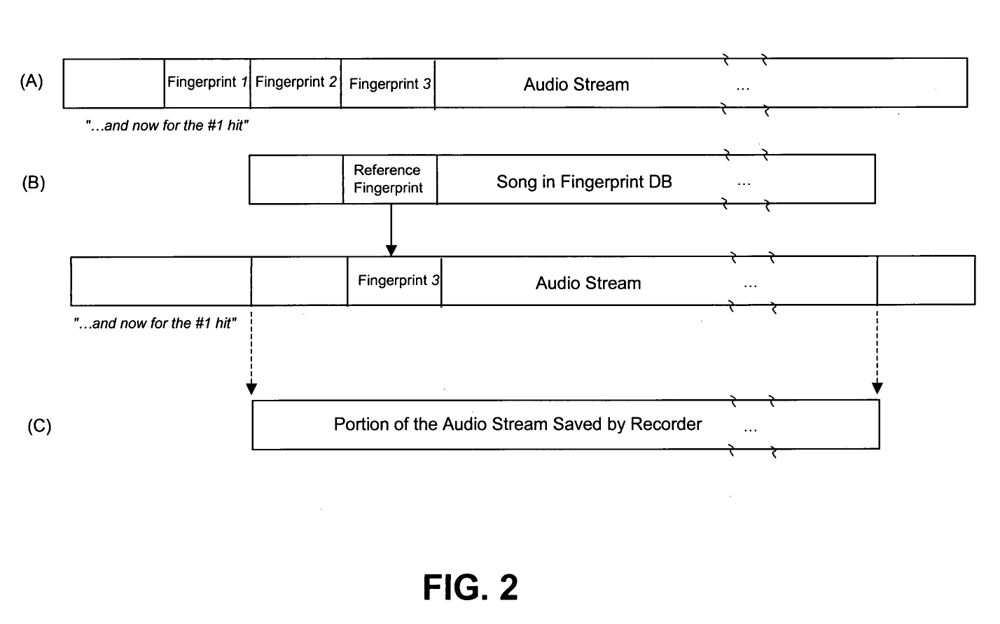

Recorder 10 preferably receives audio signals from many sources. In the embodiment illustrated in FIG. 1, at least one radio receiver 26 is incorporated as part of recorder 10 and analog-to-digital converter(s) 28 and buffer(s) 30 are provided for other audio sources 32, including Internet radio streams and removable media, such as tapes and discs of various sizes and formats, as well as semiconductor memory. However, it not essential that recorder 10 include radio receiver(s) 26. One or more external radio receiver may be connected to either analog-to-digital converter(s) 28 or digital audio stream buffer(s) 30. Likewise, components capable of reading removable media, such as compact discs may be included as a part of recorder 10, rather than being limited to external units as illustrated in FIG. 1. In addition to audio streams received via the Internet, files may be downloaded from the Internet or another device directly to storage unit 12. If such files are not adequately identified, the files may be selected for playback via user interface 36 and recognized in the manner described below with reference to FIG. 2.

In the embodiment illustrated in FIG. 1, radio receiver(s) 26 receive radio signals from radio broadcast stations represented by tower 34. If more than one radio receiver 26 is included, one receiver or tuner may be controlled directly by a user via user interface 36 while another is controlled automatically by operation controller 16 based upon previously stored instructions. User interface 36 is illustrated in FIG. 1 separate from recorder 10, but may be an integral part thereof. The previously stored instructions may have been programmed via user interface 36 or a remote device 38 connected via at least one computer network or other communication medium. For example, the remote device may be a computer executing software which directly receives instructions from the user, or a server in a client-server application, such as a World Wide Web page. In an embodiment that uses a client-server application, the user may impart instructions as the day(s) and time(s) when and frequency certain broadcast material is scheduled to be broadcast. For example, instructions to record a program Monday through Friday from 9:00 a.m. to 10:00 a.m. on 88.5 FM. This information could then be used as preset recording instructions, without regard to the broadcast material. For example, the tuner could be programmed to scan available channels for appropriate content, or programmed instructions indicating the channels to which the tuner should tune could be distributed to recorder 10 via a client-server application. Alternately, the user might impart instructions as to the type of material to record rather than specific recording instructions (i.e., record all music that is identified as Reggae from the station(s) the radio tuner is tuned to receive radio broadcasts).

Audio signals may be output to a user via one or more speakers 40. In the embodiment illustrated in FIG. 1, speaker(s) 40 are external devices connected to radio receiver(s) 26 and digital-to-analog converter 14 to receive analog signals. However, speaker(s) 40 may be incorporated into recorder 10, or may be replaced by other electronic devices, such as amplifiers, audio/video receivers, etc. capable of receiving either analog or digital signals.

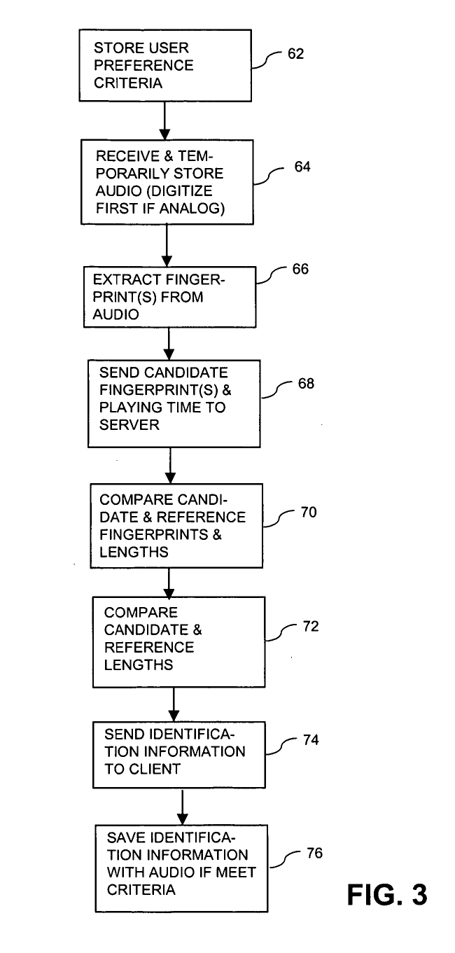

There are several modes of operation of recorder 10. All of them rely on audio, typically music, recognition. The basic operations are illustrated in FIG. 3. In all cases, user preferences are stored 62 and audio is received from a user selected or pre-programmed source and temporarily stored 64.

In the embodiment illustrated in FIG. 1, audio, typically music, recognition is performed by one or more remote service providers using either digital audio recognition 42 or analog audio recognition 44, although audio recognition could be performed by recorder 10 with few changes in the following description. During use of recorder 10 as a conventional radio receiver, operation controller 16 responds to signals received from user interface 36 to control tuning of radio receiver 26. When the user finds a song or other audio signal that he or she wants to hear, the output of receiver 26 is sent to speaker 40. If receiver 26 receives and outputs analog signals, the signals sent to speaker 40 are also sent to analog-to-digital converter 28. The output of analog-to-digital converter 28 is temporarily stored 64 in buffer 30 and supplied to audio recognizer 18. As noted above, audio recognizer 18 may be a function of a microprocessor also serving as operation controller 16, or may be implemented using separate circuitry.

Audio recognizer 18 includes an interface to communicate with a device performing digital audio (music) recognition 42 to identify the audio, as described below. Alternatively, or in addition, the analog signals may undergo analog audio (music) recognition 44 and the results thereof transmitted to audio recognizer 18. In the preferred embodiment, described in more detail below, audio signals are recognized using multiple techniques, including fingerprint recognition and song duration, or the period of time between recognized fingerprints. Buffer 30 may be large enough to hold several minutes of audio, or a much smaller amount with the entire song temporarily stored on storage device 12.

In the preferred embodiment, audio recognizer 18 extracts 66 fingerprint(s) from the audio signals and sends 68 candidate fingerprint(s) and playing time to at least one sever which performs audio recognition 42 (44) by comparing 70 the candidate fingerprint(s) with reference fingerprints for identified audio, as described in more detail below. The resulting identification information is sent 74 back to recorder 10.

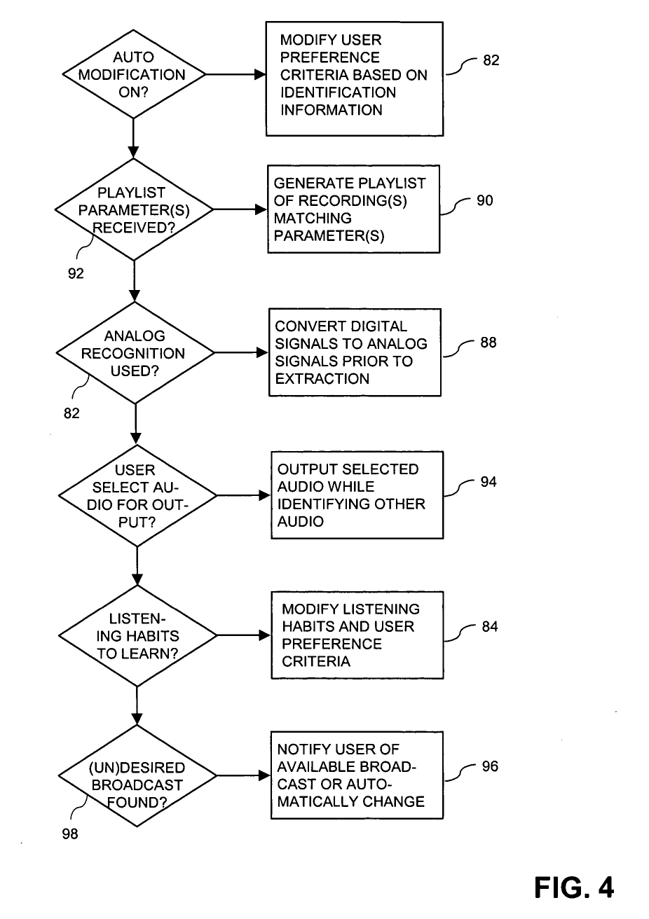

When the audio signals have been recognized, operation controller 16 or audio recognizer 18 determines whether the audio signals should be saved 76. Preferably, this is done automatically based upon the previously stored user preference criteria. In addition, user interface 36 may include a “save” button that the user can activate to save audio signals to which the user is currently listening. This is one way that user preference criteria can be created. Preferably, identification information supplied by digital (or analog) audio recognition 42 (44) includes attributes of the audio. In the case of a song, the information may include one or more of song title, artist, album(s) on which the song appears, genre of the music and a rating obtained from the music recognition service. As illustrated in FIG. 4, a heuristic process may be used to learn 82 the artists and genres saved by the user. In addition, all songs listened to by the user that can be identified may be recorded 84 as listener habit information and a similar process could be used to modify or generate the user preference criteria based on the listener habit information. Alternatively, the user may directly supply user preference criteria via user interface 36 or remote operation controller 38.

If analog audio recognition 44 is used 86, analog signals may be sent directly from receiver(s) 26 to analog audio recognition 44. However, preferably analog audio recognition is used for all audio signals. If recorder 10 is capable or receiving audio from digital sources, it is preferable to convert 88 the audio signals stored in buffer(s) 30 in digital-to-analog converter 14 and supply the output of digital-to-analog converter 14 to analog audio recognition 44. In either case, identification information obtained from analog audio recognition 44 is supplied to audio recognizer 18.

Audio files saved on storage unit 12 are accessed by operation controller 16 in response to signals received from user interface 36. Preferably, operation controller 16 is able to automatically generate 90 a playlist of at least one of the recordings based on at least one parameter received 92 from user interface 36. A system according to the present invention may generate playlists using the techniques disclosed in PLAYLIST GENERATION, DELIVERY AND NAVIGATION, U.S. patent application Ser. No. 10/228,261, filed Aug. 27, 2002, incorporated herein by reference. A file selected from such a playlist, or a directory of files stored in storage unit 12 is supplied to decoder 24 for decoding from, e.g., MP3 to WAV. The output of decoder 24 is supplied to digital-to-analog converter 14 which supplies analog signals to speaker 40.

In addition to identifying music to which a user is listening, recorder 10 is preferably capable of selecting other audio signals to be identified 94 and saved in storage unit 12. If more than one tuner 26 is included in recorder 10, a first tuner may supply audio signals just for identification, while a second tuner supplies different audio signals to speaker 40. If more than one analog-to-digital converter 28 and buffer 30 are included in recorder 10, both sets of audio signals may undergo identification, or one set of audio signals may be temporarily stored in storage unit 12 for later identification. Similarly, other audio sources 32 may supply audio signals to either be temporarily stored in storage unit 12 or in buffer 30, while undergoing identification. For example, user interface 30 or remote operation controller 38 may be used to program operation controller 16 to record specific frequencies or Internet radio streams at specific times, with or without identification. If a program guide is used to select the audio for recording, identification information obtained by identifying the audio signals may be compared with information obtained from the program guide, to verify that the recording of the audio signals saved in storage unit 12 are what the user wanted to record.

In addition, a user may instruct operation controller 16 to have audio recognizer 18 identify the different audio signals from the second tuner and automatically switch the output sent to speaker 40 from the second tuner to alternative audio signals from an alternative source, e.g., by outputting 96 the audio signals received by the first tuner, if the different audio signals are recognized 98 as undesired by the user. After making such a change, audio recognizer 18 preferably continues to identify the different audio signals from the second tuner while outputting the alternative audio signals to the user and notifies the user or automatically switches 96 the output to speaker 40 back to the different audio signals from the second tuner when the different audio signals are identified 98 as desired by the user according to at least one of the user preference criteria and listening habits of the user.

An example of how a digital audio stream may be recognized will be provided with reference to FIG. 2. In the preferred embodiment, audio streams containing a combination of a musical recording and “voice-over” from a disk jockey can be processed so that the musical recording can be identified. Such an audio stream (A) in FIG. 2, is supplied to audio recognizer 18 for extraction of fingerprints. The fingerprint extraction is preferably performed in recorder 10, but the audio stream may be supplied to digital audio recognition 42 for extraction there. If analog audio recognition 44 is used, analog signals are supplied from digital-to-analog converter 14, or radio receiver(s) 26. Since audio stream (A) contains voice-over, the initial fingerprints that are extracted are unlikely to be recognized. At some point, a candidate fingerprint, such as fingerprint 3 in the example illustrated in FIG. 2, will be identified as matching a reference fingerprint stored in a fingerprint database corresponding to song (B) using any of the techniques disclosed in Published U.S. Patent Application Nos. 20030028796 or 20030086341, or the article by Cano et al. cited above. Preferably, fingerprints continue to be extracted and compared with the fingerprints for the song (B) for the duration of the audio stream or until the song is identified. The duration of the song matching the fingerprint(s) is supplied with other identification information and storage unit 12 saves a portion of the audio stream (C) corresponding to the duration of the song identified as matching the audio stream, along with the identification information.

Since the portion (C) of the audio stream saved in storage unit 12 may include voice-over at the beginning or end, operation controller 16 or audio recognizer 18 preferably checks to see if a recording has already been saved in storage unit 12. If so, the fingerprints in the fingerprint database for the identified song may be compared with the corresponding fingerprints in the temporarily saved audio signals and the previous recording. If the temporarily saved audio signals have more matching fingerprints, the operation controller 16 or audio recognizer 18 can determine that the audio signals are perceivable as having better quality than the previous recording and can be used to replace the previous recording. Alternately, analysis of the stored audio could indicate the presence of voice-over marking each song with voice-over as a less preferable recording.

The present invention has been described with respect to an embodiment with specific components. However, there are many variations in the components and services that can be used with the invention.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of recording audio, comprising:
storing user preference criteria;
identifying audio signals using a database of previously identified audio signals;
determining duration of the audio signals based on said identifying; and
saving a recording of the audio signals based on the user preference criteria and the duration.

2. A method as recited in claim 1,
wherein said identifying comprises:
extracting from the audio signals at least one candidate fingerprint using at least one technique; and
comparing the at least one candidate fingerprint with at least one database of reference fingerprints for identified recordings, and
wherein said method further comprises supplying identification data corresponding to at least one reference fingerprint that said comparing finds matches the at least one candidate fingerprint and the duration.

3. A method as recited in claim 2,
wherein said extracting uses a plurality of techniques to extract a plurality of candidate fingerprints, and
wherein said comparing uses the plurality of candidate fingerprints.

4. A method as recited in claim 3, wherein said determining the duration comprises:
detecting a candidate length of at least part of the recording; and
comparing the candidate length with reference lengths of the identified recordings.

5. A method as recited in claim 4, wherein said saving replaces a previous recording if said identifying matches the audio signals with one of the identified recordings which also matches the previous recording and the audio signals are perceivable as having better quality than the previous recording.

6. A method as recited in claim 4,
further comprising sending at least the plurality of candidate fingerprints and playing time information from a client device performing said saving to at least one server device storing the at least one database,
wherein said comparing is performed by the at least one server device, and
wherein said supplying is performed via a network transmitting the identification data from the at least one server device to the client device.

7. A method as recited in claim 4, wherein the identification information includes at least one of artist, genre and rating.

8. A method as recited in claim 7, wherein said saving includes comparing the at least one of artist, genre and rating in the identification data with the user preference criteria to determine whether to save the recording of the audio signals.

9. A method as recited in claim 3, wherein the plurality of techniques include both digital fingerprints and analog fingerprints.

10. A method as recited in claim 2, wherein said saving further includes saving the identification data with the recording.

11. A method as recited in claim 10,
wherein said saving is performed for a plurality of recordings, and
wherein the identification information includes at least one of artist, genre and rating.

12. A method as recited in claim 11, further comprising modifying the user preference criteria based on at least part of the identification information saved with the recordings.

13. A method as recited in claim 11, further comprising notifying a user of currently broadcast audio signals matching the user preference criteria.

14. A method as recited in claim 11, further comprising:
receiving at least one parameter from a user; and
automatically generating a playlist of at least one of the recordings based on the at least one parameter.

15. A method as recited in claim 1, further comprising:
receiving the audio signals at a local device from a remote device; and
temporarily storing the audio signals as the recording until said identifying is completed.

16. A method as recited in claim 15, wherein the audio signals are received as analog signals via a first radio broadcast on a first frequency.

17. A method as recited in claim 15, wherein said method further comprises converting the analog signals to digital signals prior to said identifying.

18. A method as recited in claim 15, further comprising outputting different audio signals from a different source to a user during said receiving.

19. A method as recited in claim 18, further comprising receiving the different audio signals via a second radio broadcast on a second frequency during said receiving of the first radio broadcast.

20. A method as recited in claim 19, further comprising providing a user interface for determining the audio signals received via the first radio broadcast regardless of whether the different audio signals are being output.

21. A method as recited in claim 20, wherein said providing includes a manual interface on the local device.

22. A method as recited in claim 20, wherein said providing is performed on a programming device separate from the local device.

23. A method as recited in claim 22,
wherein the local device and the programming device are connected via a network, and
wherein said providing includes accepting input from the user regarding at least one of broadcast time, a radio station broadcasting the audio signals, radio station format, genre of broadcast audio, popularity of broadcast audio, location of broadcaster, year of broadcast, language of broadcast and minimum quality of the audio signals.

24. A method as recited in claim 20, wherein said providing includes displaying program information about audio signals broadcast on the second frequency.

25. A method as recited in claim 15, further comprising outputting different audio signals from a different source to a user during said receiving.

26. A method as recited in claim 25, further comprising:
identifying the different audio signals; and
saving identification information matching the different audio signals as listening habit information.

27. A method as recited in claim 26, further comprising modifying the user preference criteria based on the listening habit information.

28. A method as recited in claim 26, further comprising notifying a user of currently broadcast audio signals matching at least one of the user preference criteria and the listening habit information.

29. A method as recited in claim 25, further comprising scanning a plurality of different sources for currently broadcast audio signals matching the user preference criteria.

30. A method as recited in claim 25, wherein said receiving uses at least one computer network for transmission of a digital audio stream.

32. A method as recited in claim 25, further comprising:
identifying the different audio signals; and
automatically switching output of the different audio signals to the user from the different source to alternative audio signals from an alternative source if the different audio signals are recognized as undesired by the user.

33. A method as recited in claim 32, further comprising:
continuing to identify the different audio signals from the different source while outputting the alternative audio signals to the user; and
automatically switching output to the user back to the different audio signals from the different source when the different audio signals are identified as desired by the user according to at least one of the user preference criteria and listening habits of the user.

34. An apparatus for identifying and recording audio, comprising:
at least one storage unit to store user preference criteria and recordings with associated identification information; and
at least one processor, coupled to said at least one storage unit, to identify audio signals using at least one database of previously identified audio signals, determine duration of the audio signals based on identification thereof, and control saving of a recording of the audio signals in said at least one storage unit based on the user preference criteria and the duration.

35. An apparatus as recited in claim 34,
wherein at least one audio recognition service external to said apparatus maintains the at least one database of previously identified audio signals, and
wherein said apparatus further comprises at least one interface coupled to said at least one processor and the at least one audio recognition service.

36. An apparatus as recited in claim 35,
wherein said at least one processor extracts from the audio signals at least one candidate fingerprint using at least one technique, and
wherein the at least one audio recognition service compares the at least one candidate fingerprint with the at least one database of reference fingerprints for identified recordings, and sends to said at least one interface identification data corresponding to at least one reference fingerprint that matches the at least one candidate fingerprint and the duration.

37. An apparatus as recited in claim 36,
wherein said at least one processor extracts a plurality of candidate fingerprints using a plurality of different techniques, and
wherein the at least one audio recognition service compares the plurality of candidate fingerprints with a plurality of databases of reference fingerprints

38. An apparatus as recited in claim 35, wherein the at least one audio recognition service extracts from the audio signals at least one candidate fingerprint using at least one technique, compares the at least one candidate fingerprint with the at least one database of reference fingerprints for identified recordings, and sends to said at least one interface identification data corresponding to at least one reference fingerprint that matches the at least one candidate fingerprint and the duration.

39. An apparatus as recited in claim 34, further comprising at least one receiver, coupled to said at least one processor, to receive at least some of the audio signals as broadcast radio.

40. An apparatus as recited in claim 39, further comprising at least one interface, coupled to said storage unit, to receive at least some of the audio signals from a local playback device.

41. An apparatus as recited in claim 39,
wherein the at least one receiver includes at least two tuners for receiving the broadcast radio on at least two frequencies, and
wherein the at least one processor automatically controls at least one of the tuners according to programmed instructions.

42. At least one computer readable medium storing instructions executable by at least one processor to perform a method of recording audio, comprising:
storing user preference criteria;
identifying audio signals using a database of previously identified audio signals;
determining duration of the audio signals based on said identifying; and
saving a recording of the audio signals based on the user preference criteria and the duration.

43. An apparatus for identifying and recording audio, comprising:
storage means for storing user preference criteria and recordings of audio signals; and
identification means for identifying audio signals using a database of previously identified audio signals and for determining duration of the audio signals based on said identifying, said storage means saving a recording of the audio signals based on the user preference criteria and the duration.
